(19) United States
(12) Patent Application Publication
(10) Pub. No.: US 2009/0113889 A1
(43) Pub. Date: May 7, 2009

(54) Catalytic burner for stirling engine

(76) Inventors: Subir Roychoudhury, Madison, CT (US); Jonathan Berry, Simponville, SC (US)

Correspondence Address: Robert L. Rispoli;Patent Counsel, Precision Combustion, Inc., 410 Sackett Point Road, North Haven, CT, 06473, US

(21) Appl. No.: 11/364,402

(22) Filed: Feb. 28, 2006

(51) Int. Cl. F02G 1/043

(52) U.S. Cl. 60/524; 431/268

(57) ABSTRACT

The invention provides a method for transferring heat by conduction to the internal heat acceptor of an external combustion engine. Fuel and air are introduced and mixed to form an air/fuel mixture. The air/fuel mixture is directed into a catalytic reactor that is positioned substantially adjacent to the heater head. Heat is transferred via conduction from the catalytic reactor to the heater head and the catalytic reaction products are exhausted.

### GOVERNMENT RIGHTS

This invention was made with government support under U.S. Contract No. W911-NF-04-1-0238, Subaward No. Y-04-0023. The U.S. government holds certain rights in this invention.

### FIELD OF THE INVENTION

The present invention is generally directed to a method for providing heat to an external combustion engine. More particularly, the present invention is directed toward providing substantially conductive heat transfer to the internal heat acceptor, commonly referred to the heater head, of a Stirling Engine.

### BACKGROUND OF THE INVENTION

As is well known in the art, Stirling Engines convert a temperature difference directly into movement. Such movement, in turn, may be converted into mechanical or electrical energy. The Stirling Engine cycle comprises the repeated heating and cooling of a sealed amount of working gas. When the gas in the sealed chamber is heated, the pressure increases and acts on a piston thereby generating a power stroke. When the gas in the sealed chamber is cooled, the pressure decreases and is acted upon by the piston thereby generating a return stroke.

Stirling Engines, however, require an external heat source to operate. The heat source may be the result of combustion and may also be solar or nuclear. In practicality, the rate of heat transfer to the working fluid within the Stirling Engine is one primary mechanism for increasing the power output of the Stirling Engine. One skilled in the art, however, will recognize that power output may be increased through a more efficient cooling process as well.

U.S. Pat. No. 5,590,526 to Cho describes a conventional prior art burner for a Stirling Engine. Generally, a combustion chamber provides an air-fuel mixture for the burner by mixing air and fuel supplied from air inlet passageways and a fuel injection nozzle, respectively. An igniter produces a flame by igniting the air-fuel mixture formed within the combustion chamber. A heater tube absorbs high temperature heat generated by the combustion of the air-fuel mixture and transfers the heat to the Stirling Engine working fluid. Exhaust gas passageways discharge an exhaust gas.

A more efficient heat source is described in U.S. Pat. No. 5,918,463 to Penswick, et al. (hereinafter referred to as “Penswick”) in order to overcome the problem of delivering heat at non-uniform temperatures. As described by Penswick, Stirling engines require the delivery of concentrated thermal energy at uniform temperature to the engine working fluid. (See Penswick Column 1, lines 39-40). In the approach disclosed by Penswick, a burner assembly transfers heat to a Stirling Engine heater head primarily by radiation and secondarily by convection. (See Penswick Column 1, lines 58-61). Penswick discloses the device with respect to an external combustion engine, a Stirling Engine, and a Stirling Engine power generator. (See Penswick Column 2, lines 36-66).

With respect to the external combustion engine, the Penswick burner assembly includes a housing having a cavity sized to receive a heater head and a matrix burner element carried by the housing and configured to transfer heat to the heater head. (See Penswick Column 2, lines 38-41). With respect to the Stirling Engine, the Penswick burner assembly includes a housing having a cavity sized to receive a heater head and a matrix burner element configured to encircle the heater head in spaced apart relation. (See Penswick Column 2, lines 48-51). Lastly, with respect to the Stirling Engine power generator, the Penswick burner assembly includes a housing having a cavity sized to receive the heater head and a matrix burner element configured to encircle the heater head in spaced apart relation. (See Penswick Column 2, lines 63-66).

The Penswick burner housing supports a fiber matrix burner element in radially spaced apart, but close proximity to, a radially outer surface of the Stirling Engine heater head. (See Penswick Column 4, lines 19-21). Penswick further discloses that combustion may occur in radiant or blue flame. In the radiant mode, combustion occurs inside matrix burner element which, in turn, releases a major portion of the energy as thermal radiation. In the blue flame mode, blue flames hover above the surface and release the major part of the energy in a convective manner. (See Penswick Column 4, lines 42-54). Hence, operation of the Penswick burner requires space between the combusting matrix element and the heater head in order to operate in any of the modes disclosed by Penswick.

Moreover, Penswick describes a heat chamber that is formed within the burner housing between the inner surface of the matrix burner element and the outer surface of the Stirling Engine heater head. Heat transfer occurs within the heat chamber primarily through radiation from the matrix burner element to the Stirling Engine heater head, and secondarily via the passing of hot exhaust gases over the Stirling Engine heater head. (See Penswick Column 6, lines 1-7, and FIG. 5). According to Penswick, heat being delivered through the heat chamber and over the Stirling Engine heater head is conserved as a result of insulation. (See Penswick Column 7, lines 17-20). However, a problem still exists in the art with respect to enhancing the efficiency of the operation of a Stirling Engine.

As recognized by one skilled in the art, the uniform burning of a matrix burner element remains a problem. In U.S. Pat. No. 6,183,241 to Bohn, et al. (hereinafter referred to as “Bohn”), computer simulation was employed to develop an inward-burning, radial matrix gas burner to attempt to solve the difficulty of obtaining uniform flow and uniform distribution in a burner matrix. (See Bohn, Abstract and Column 1, lines 54-56). According to Bohn, metal matrix burners have received much attention because of their ability to burn fossil fuels with very low emissions of nitrogen oxides. (See Bohn, Column 1, lines 37-39). With respect to the transfer of heat to the Stirling Engine heater head, Bohn also teaches that a significant fraction of the heat of combustion is released as infrared radiation from the matrix. (See Bohn, Column 1, lines 42-44).

Bohn's solution provides a high-temperature uniform heat via a cylinder-shaped radial burner, a curved plenum, porous mesh, divider vanes, and multiple inlet ports. Extended upstream fuel/air mixing point provide for uniform distribution of a preheated fuel/air mixture. (See Bohn, Column 4, lines 56-61). Bohn teaches the use of a space formed between a heat pipe and the burner matrix and the use of a mesh screen therebetween to promote uniform radiant heat transfer. Unfortunately, the solution offered by Bohn still is too complex and inefficient for desired uses.

Yet another method for transferring heat to the heater head of a Stirling Engine is disclosed in U.S. Pat. No. 6,877,315 to Clark, et al. (hereinafter referred to as “Clark”). According to Clark, the Stirling Engine heater head is generally arranged vertically with a burner surrounding it to supply heat so that hot exhaust gases from the burner can escape upwards. The device disclosed by Clark enhances the transfer of heat to the Stirling Engine heater head to increase its efficiency by employing fins to increase the heater head surface area. (See Clark, Column 1, lines 19-33). Clark teaches that a problem still exists in the art with respect to the effective and efficient transfer of heat to a Stirling Engine heater head as late as 2003.

In the device disclosed by Clark, an annular burner surrounds the heat transfer head and provides the heat source. The heat transfer head is provided with a plurality of fins to promote and enhance heat transfer. (See Clark, FIG. 1 and Column 2, lines 34-45). Radiant heat is transferred to the heater head and also to other substantially parallel fins to further enhance the heat transfer. (See Clark, Column 1, lines 63-65). As with the other prior art cited, the relative spaced-apart relationship that allows heat to be transferred radiantly is important. Clark teaches that the source of radiant heat is arranged opposite to the plurality of fins such that radiant heat is directed into the spaces between adjacent fins. (See Clark, Column 3, lines 4-6).

Another problem with burner devices for a Stirling Engine is described in U.S. Pat. No. 6,513,326 to Maceda, et al. (hereinafter referred to as “Maceda”). Maceda discloses a conventional burner device in which air and fuel are injected into the burner and then ignited to cause heat to be generated. The working gas is carried within a plurality of heater tubes that are positioned proximate to the burner device so that heat is transferred from the burner device to the working gas flowing within the heater tubes. (See Maceda, Column 1, lines 39-46). As known to one skilled in the art, the heater tubes are positioned proximate to the burner device such that heat can be radiantly transferred from the burner device to the tubes.

According to Maceda, heat is not uniformly distributed to the working gas within the heater tubes because a single burner device is used to generate and effectuate the heat transfer. (See Maceda, Column 1, lines 55-59). As a solution to the problem of uniform heat distribution, Maceda teaches the use of a heat exchange manifold employing multiple platelets that are stacked and joined together. (See Maceda, Column 2, lines 22-24). Instead of having one large burner device with one combustion chamber and a multiple of heater tubes per piston cylinder, the Maceda manifold provides a substantially greater number of individual combustion chambers. (See Maceda, Column 2, lines 51-57). Unfortunately, the solution offered by Bohn still is too complex and inefficient for desired uses.

Based on the foregoing, what is need is a simple, efficient and effective method for generating and transferring heat to the heater head of a Stirling Engine.

### SUMMARY OF THE INVENTION

The present invention provides a simple, efficient and effective method for generating and transferring heat to the heater head of a Stirling Engine. It has now been found that a catalytic reactor comprising catalyst deposited on ultra-short-channel-length metal mesh elements, known as Microlith® and commercially available from Precision Combustion, Inc., located in North Haven, Conn., efficiently and effectively generates heat as a burner within the operative constraints for a Stirling Engine known within the art. More importantly and in contrast to the prior art, the catalytic reactor comprising catalyst deposited on Microlith® ultra-short-channel-length metal mesh elements may be positioned in direct (i.e., non spaced-apart) communication with the heater head thereby providing heat transfer by thermal conduction, the most efficient manner of heat transfer in Stirling Engine applications.

Microlith® ultra-short-channel-length metal mesh technology is a novel reactor engineering design concept comprising of a series of ultra-short-channel-length, low thermal mass metal monoliths that replaces the long channels of a conventional monolith. Microlith® ultra-short-channel-length metal mesh design promotes the packing of more active area into a small volume, providing increased reactivity area for a given pressure drop. Whereas in a conventional honeycomb monolith, a fully developed boundary layer is present over a considerable length of the device, the ultra short channel length characteristic of the Microlith® substrate avoids boundary layer buildup. Since heat and mass transfer coefficients depend on the boundary layer thickness, avoiding boundary layer buildup enhances transport properties. The advantages of employing Microlith® ultra-short-channel-length metal mesh as a substrate to control and limit the development of a boundary layer of a fluid passing therethrough is described in U.S. patent application Ser. No. 10/832,055 which is a Continuation-In-Part of U.S. Pat. No. 6,746,657 to Castaldi, both incorporated in their entirety herein.

In one embodiment of the present invention, a catalytic reactor comprises a catalytically reactive Microlith® ultra-short-channel-length metal mesh positioned in close proximity to (i.e., not spaced-apart from or in physical connection with) thermally conductive walls. Use of the catalytically reactive Microlith® ultra-short-channel-length metal mesh in this manner provides for: rapid catalytic light-off; excellent robustness for different fueling rates; and easy replacement of the catalytic reactor burner section of the Stirling Engine. The thermally conductive walls of the catalytic reactor minimize the potential for the overheating of the catalyst even at equivalence ratios near 1.0. Energy, in the form of heat, is rapidly extracted from the catalytic fuel oxidation zone.

Any conventional air supply, fuel supply, and air/fuel mixing technique may be employed to provide these feeds to a device according to the present invention. Any conventional mounting technique may be employed to mount a device according to the present invention within thermal conductivity to the heater head of the Stirling Engine.

In further contrast to the prior art, the present invention comprises a flameless combustion zone. As those skilled in the art know, combustion comprising a flame must address adiabatic flame temperature conditions and provide flame-holding techniques. As with all fuel-consuming systems, auto-ignition also must be addressed.

In another embodiment of the present invention, the catalytic burner employs an electrohydrodynamic liquid fuel dispersion system, generally referred to as an electrosprayer, as described in significant detail in U.S. patent application Ser. No. 10/401,226 of in the names of Gomez and Roychoudhury; filed on Mar. 27, 2003, and claiming priority to U.S. Provisional Patent Application No. 60/368,120.

### BRIEF DESCRIPTION OF THE DRAWINGS

FIG. 1 provides a top view of a Stirling Engine heater head surrounded by a catalyst bed and catalyst holder in accordance with the method of the present invention.

FIG. 2 provides a side view cut-away along Line A-A of the Stirling Engine heater head depicted in FIG. 1.

FIG. 3 provides a schematic cut-away of an external combustion engine employing a Stirling Engine heater heat in turn employing a heat source according to the method of the present invention.

### DETAILED DESCRIPTION OF THE INVENTION

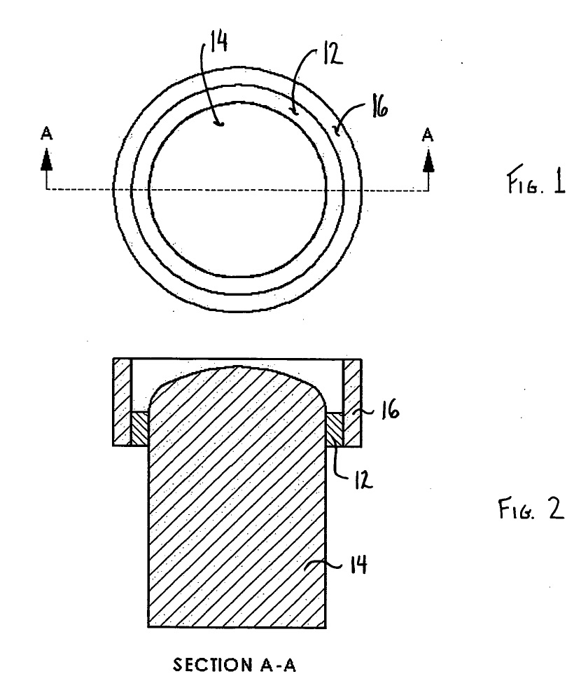

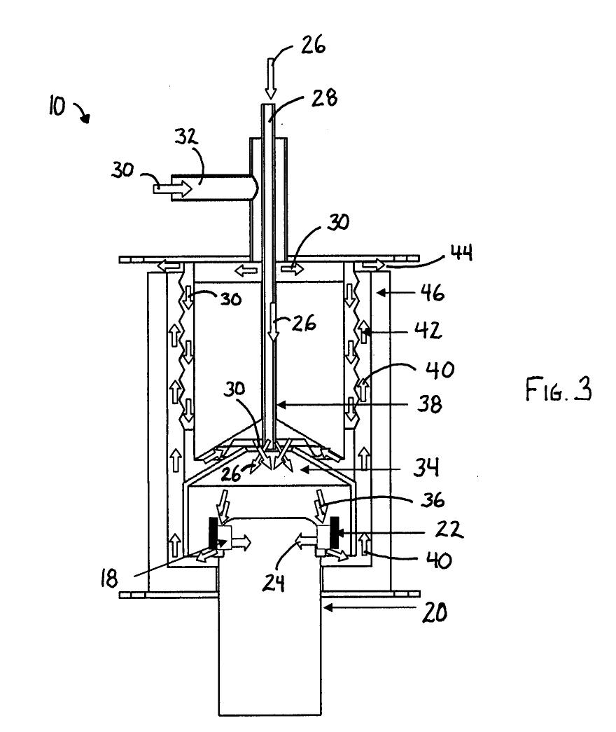

As shown in FIGS. 1 and 2 and generally referred to as heat conduction method 10 in FIG. 3, catalytic reactor 12 is positioned in communication with heater head 14, and rigidly held in place by catalyst holder 16. Catalytic reactor 12 comprises catalyst deposited on Microlith® ultra-short-channel-length metal mesh elements. The reactor provides heat transfer to heater head 14 by thermal conduction. Catalyst holder 16 also serves as a heat exchanger with respect to the heat generated by the catalytic reactor 12 and transferred to the gases passing over and in proximity to catalyst holder 16.

As depicted in FIGS. 2 and 3, heat conduction method 10 comprises a catalytic reactor 18 positioned in communication with Stirling Engine heater head 20, and held in place by catalyst holder 22. Catalytic reactor 18 provides heat transfer to heater head 20 by thermal conduction 24 through internal heat acceptor 25. In the embodiment of the invention depicted, fuel 26 is introduced via fuel injection path 28 and air 30 is introduced via air injection path 32. Fuel 26 and air 30 are mixed in region 34 providing fuel/air mixture 36. The mixing of fuel 26 and air 30 is advantageously enhanced by incorporating an electrospray nozzle 38 and swirler 39 within fuel injection path 28 such as the method for electrospraying fuels disclosed in U.S. patent application Ser. No. 10/401,226; filed on Mar. 27, 2003, and claiming priority to U.S. Provisional Patent Application No. 60/368,120; which description of such electrospray method is incorporated herein by reference. Catalytic combustion reactants 40 exit catalytic reactor 18 and flow through recuperator 42 until they exit the system at exhaust port 44. Recuperator 42 may be surrounded by insulation layer 46.

The catalytic reactor 18 of the embodiment described above with reference to FIG. 3 comprises the catalytically reactive Microlith® ultra-short-channel-length metal mesh positioned in close proximity to (i.e., not spaced-apart from or in physical connection with) thermally conductive walls. Catalytic reactor 18 further comprises at least one catalyst known in the art for fuel oxidation such as, for example, platinum or palladium on alumina. Fuel 26 comprises conventional JP-8 fuel, and the air/fuel mixing method comprises a method for electrospraying fuels as disclosed in U.S. patent application Ser. No. 10/401,226. Recuperator 42 provides heat transfer from catalytic combustion reactants 40 exiting catalytic reactor 18 and flowing through recuperator 42 to air 30 flowing through air injection path 32.

While the present invention has been described in considerable detail, other configurations exhibiting the characteristics taught herein for improved heat generation and transfer to the heater head of a Stirling Engine by thermal conduction employing flameless combustion are contemplated Therefore, the spirit and scope of the invention should not be limited to the description of the preferred embodiments described herein. external combustion engine comprising: a) introducing fuel into an air/fuel mixing region; b) introducing air into the air/fuel mixing region; c) forming an air/fuel mixture; d) directing the air/fuel mixture into a catalytic reactor positioned substantially adjacent to the heater head; e) catalytically combusting the air/fuel mixture thereby producing heat and combustion products; and f) conductively transferring heat to the heater head. 7. (original) The method of claim 6 wherein the step of introducing fuel into an air/fuel mixing region comprising electrospraying the fuel into the air/fuel mixing region.

1. A method for providing heat to an internal heat acceptor of an external combustion engine comprising:
a) introducing a fuel into a fuel inlet;
b) passing the fuel into an air/fuel mixing region;
c) introducing air into an air inlet;
d) passing the air into the air/fuel mixing region;
e) mixing the fuel and the air in the air/fuel mixing region and thereby forming an air/fuel mixture;
f) directing the air/fuel mixture into a catalytic reactor positioned substantially adjacent to the internal heat acceptor;
g) catalytically combusting the air/fuel mixture thereby producing heat and combustion products;
h) providing substantially conductive heat transfer to the internal heat source;
i) exhausting the combustion products.

2. The method of claim 1 wherein the step of passing the fuel into an air/fuel mixing region comprising electrospraying the fuel into the air/fuel mixing region.

3. The method of claim 1 including the additional step of transferring heat via a conventional heat exchanger from the combustion products to the air.

4. The method of claim 1 wherein the fuel comprises liquid fuel.

5. The method of claim 1 wherein the fuel comprises gaseous fuel.

6. A method for transferring heat to an internal heat acceptor of an external combustion engine comprising:
a) introducing fuel into an air/fuel mixing region;
b) introducing air into the air/fuel mixing region;
c) forming an air/fuel mixture;
d) directing the air/fuel mixture into a catalytic reactor positioned substantially adjacent to the heater head;
e) catalytically combusting the air/fuel mixture thereby producing heat and combustion products; and
f) conductively transferring heat to the heater head.

7. The method of claim 6 wherein the step of introducing fuel into an air/fuel mixing region comprising electrospraying the fuel into the air/fuel mixing region.
